(19) United States
(12) Patent Application Publication
(10) Pub. No.: US 2014/0106328 A1
(43) Pub. Date: Apr. 17, 2014

(54) SURGICAL TRAINING APPARATUS

(71) Applicant: THE CLEVELAND CLINIC FOUNDATION, Cleveland, OH (US)

(72) Inventor: Gabriel Loor, Cleveland, OH (US)

(73) Assignee: THE CLEVELAND CLINIC FOUNDATION, Cleveland, OH (US)

(21) Appl. No.: 14/056,048

(22) Filed: Oct. 17, 2013

Related U.S. Application Data
(60) Provisional application No. 61/714,877, filed on Oct. 17, 2012.

(51) Int. Cl. G09B 23/28

(52) U.S. Cl. CPC G09B 23/285
USPC 434/272

(57) ABSTRACT

Surgical training apparatus including a box having a base and side walls, where the top of the box is substantially open. The box dimensions are scaled so that the open top simulates a body opening through which a surgical procedure is to be performed. At least one elongated, articulated support arm is disposed within the box. At least one suturable surgical practice component is affixed to at least one end of the support arm. The training apparatus may have multiple differently sized openings for providing different constraints to the surgeon, and ported inserts may be provided to allow practice of minimally invasive surgical procedures.

### CROSS-REFERENCE TO RELATED APPLICATION

This application claims the benefit of U.S. Provisional Patent Application No. 61/546,807, filed Oct. 13, 2011, and entitled ESTIMATION OF NEURAL RESPONSE FOR OPTICAL STIMULATION, the contents of which is incorporated herein in its entirety.

### FIELD OF THE INVENTION

The present invention is directed to apparatus for training a surgeon in certain tasks and skills that are useful in surgical procedures, particularly cardiothoracic surgery.

### BACKGROUND

The practice of cardiothoracic surgery is generally unforgiving and indeed is growing more difficult as the complexity of new procedures increases. This creates a very challenging environment for a fledgling surgeon who yet lacks substantial cardiothoracic surgical experience. The angles necessary to suture on vertical surfaces along the beating heart deep within the chest require time to learn. In addition, general surgery trainees are often not extensively trained with the particular instruments used in this surgery (e.g., Castro-Viejo needle drivers and other long needle drivers). The thin prolene sutures that are often used are easy to break and only experience can teach a surgeon the right amount of tension to apply in order to secure a vessel without fracturing it. Surgeons acquire helpful experience with each passing procedure they perform, but an operating theater is not an appropriate forum for learning fundamental skills in the first place, and live procedures cannot be performed repetitively to achieve rapid proficiency.

Some other training options are available for various types of medical procedures. 3D simulators are available, for example, for the specialized training required to use the DaVinci robot in cardiac surgery. Mannequins are available with models of hearts, valves and aortas. ‘Pig labs’ are frequently conducted to teach residents new skills. Unfortunately these training methods are expensive, not easily mobile, and not readily accessible to residents on a daily basis. Anecdotally, some cardiac surgeons may have improvised ad hoc training guides using, e.g., lamp shades to simulate the constraints of the thorax, and bed sheets and purse strings for suturing practice, etc. Such improvised training guides are awkward and poorly suited to the training exercise.

Box simulators are available for laparoscopy and for practicing basic general surgery suturing and tying, but not for delicate needle handling within the confines of the chest. Some medical suppliers (e.g., Gore, Medtronic) offer very basic platforms that showcase their suturing and graft products but these are insufficient to provide the array of skills necessary for a cardiac resident in training.

The medical profession would benefit from a training tool that would allow convenient and deliberate practice for the surgeon-in-training at any time at work or at home. Such a tool would allow the surgeon to achieve the repetition required to gain proficiency in cardiac surgical skills. Although a training tool is never a substitute for experience in an operating room, it would orient the new cardiac surgeon to basic skills that must be mastered prior to effectively executing them in a patient.

The present invention provides a box-like surgical training tool that is inexpensive, durable, and closely simulates the complexities of operating on the human heart. The box trainer in accordance with the present invention will be available for resident and other surgeons easily to practice hundreds of suture and tying drills in their homes or offices. Each drill could take as little as ten minutes or as long as an hour; but the drill can be performed over and over again on a routine basis. The drills enabled by the present surgical training tool will improve the surgeon's ability and confidence in the operating theater, preparing the surgeon to participate and excel in critical portions of cardiothoracic operations on living human patients.

In accordance with one example embodiment of the present invention, a surgical training apparatus is provided. The apparatus includes a box having a base and side walls, where the top of the box has an opening therein. The box is sized so that the top opening is large enough to at least partially receive the hands of a surgeon and thereby to simulate a body opening through which a surgical procedure is manually performed. At least one elongated, articulated support arm is disposed within the box. At least one suturable surgical practice form is affixed to at least one end of the support arm.

In accordance with another example embodiment of the present invention, the surgical training apparatus is equipped with at least two differently sized openings through which surgical procedures may be practiced.

In accordance with yet another example embodiment of the present invention, a surgical training apparatus is provided having at least one opening adapted to be covered by a ported insert through which minimally invasive surgical procedures may be practiced.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of a surgical trainer in accordance with the present invention, set up for practicing aortic valve replacement;

FIG. 2 is a cross section of a portion of the fixture of FIG. 1, taken along lines 2-2 in FIG. 1, showing one manner in which the holding annulus, bell frame, and sewing ring may be nested together;

FIG. 3 is a perspective view of other bell frames that may be snapped into the holding annulus for simulating other heart valve replacement environments;

FIG. 4 is a perspective view of the surgical trainer set up for practicing aortic graft anastamosis;

FIG. 5 is a perspective view of the surgical trainer set up for practicing coronary anastamosis or canulating processes;

FIG. 6 is a perspective view of an embodiment of the surgical trainer having an auxiliary side opening for providing alternative space restrictions in surgical training procedures;

FIG. 7 is a perspective view of the embodiment of FIG. 6 having an elastomeric covering over the auxiliary side opening for permitting a surgeon to practice minimally invasive surgical procedures; and,

FIG. 8 is a perspective view of a variation of the embodiment of FIG. 7.

### DETAILED DESCRIPTION

The human heart contains four one-way valves for controlling the flow of blood into and out of the heart. The mitral and tricuspid valves are found between respective ones of the atria and the ventricles, while the aortic and pulmonary valves are found in respective arteries leaving the heart. Techniques have been developed for replacement of each of these valves. A goal of the present invention is to provide apparatus that will allow a surgeon to practice the surgical techniques for replacement of each valve within environments that mimic the constrained spaces and difficult orientations of the human heart. The training tool simulates operating within the constraints of the open chest, with low cost and durable materials that allow convenient and repetitive practice in any environment including home or work.

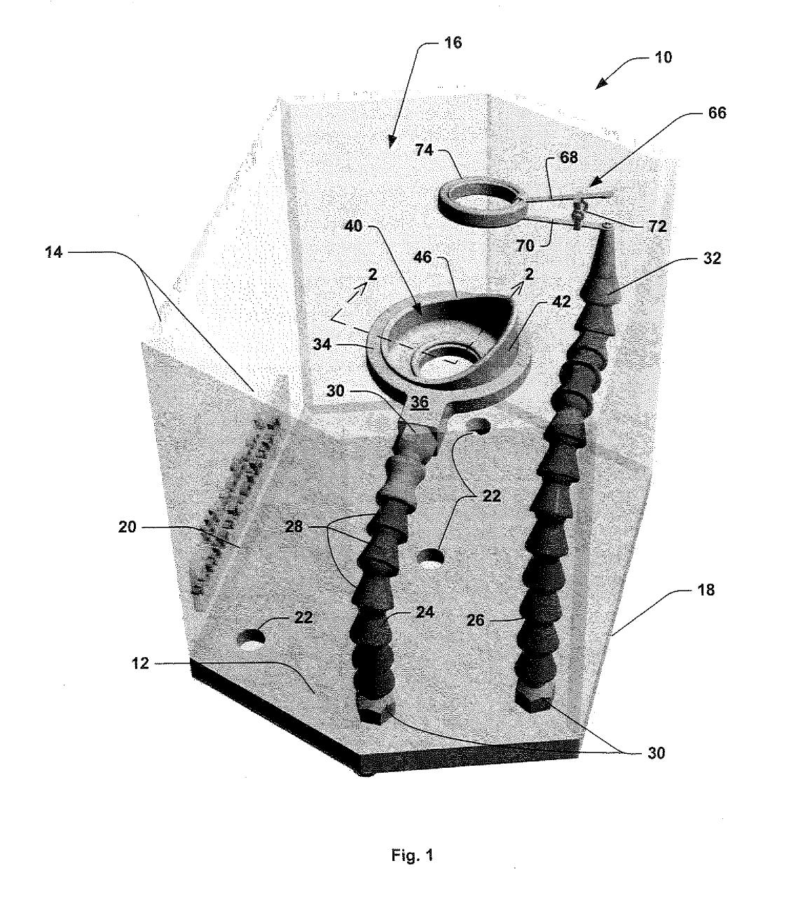

Referring to FIG. 1, the apparatus 10 includes a box having a base 12, upstanding sides 14, and an open top 16. In the illustrated example embodiment the base 12 is generally hexagonal, however two of the opposing sides 18 and 20 are somewhat longer than the remaining four sides such that the base presents a generally oblong shape. Six side panels 14 are attached to respective sides of the base, forming an upright structure whose horizontal section is similarly oblong-hexagonal. This shape has been found to be convenient, but boxes having other horizontal sections (e.g., round, oval, square) may instead be used.

The box may be approximately one foot in each of the height, width, and depth dimensions (with, perhaps, a somewhat smaller depth, as shown, to enclose an oblong space). More specifically, the dimensions of the box as well as the heights of the different suturing substrates are selected to correspond to average measurements obtained from three dimensional reconstructions of multiple patients with particularly challenging anatomy (i.e., COPD, aortic aneurysm, atrial enlargement). This dimensioning increases the high fidelity feel of the suturing simulation. With dimensions thus chosen, the box is large enough in volume to contain multiple and interchangeable suture stations, and the height will to ensure that the operator's wrists and elbows are sufficiently constrained to mimic the operating environment.

More specifically, based on measurements taken from a reasonable sample of typical patients, the dimensions of the box are preferably as follows:

| Height: | 15.8 cm |
|---|---|
| Length: | 17.9 cm |
| Width: | 13.7 cm |
| Vertices (two end angles): | 140° |
| Vertices (four side angles): | 110 |

The precision of, and general preference for, the above dimensions notwithstanding, boxes constructed with different but generally similar cavity sizing are also within the scope of the invention so long as the overall effect is to mimic the intended operating environment. The box is relatively small (volume much less than one cubic foot), whereby the box is lightweight and portable and may conveniently be moved from place to place and stored when not in use.

The box is constructed of Lucite, although any other materials may instead be used. The panels that make up the base and sides are thick enough, e.g. one half inch in thickness, that the box is solid, will not shift about during use, and serves as a strong foundation for attachment of interior pieces of the apparatus. In the illustrated embodiment the sides are glued to one another and to the base, but other fastening methods may be used such as, for example, mechanical fasteners or ultrasonic or laser welding.

The box is designed to receive a variety of inserts to fasten grafts, cannulation substrates and surfaces, materials for tying, synthetic coronary targets and valve annuluses. To this end, the base 12 has a number of holes 22 drilled through it. In the illustrated embodiment five holes are provided, four near respective vertices of the base and the fifth in the center.

Machine screws, not visible in the figure, are inserted through these holes to secure one or more articulated arms for supporting a variety of surgical practice devices. In FIG. 1, two articulated support arms 24 and 26 are thus secured. In the illustrated embodiment, the arms are formed of a linear series of short interlocking ball and socket segments. The many ball and socket junctions provide significant flexibility in all three dimensions, while also providing sufficient friction in the ball and socket joints to hold the arms in the positions to which they are moved. Suitable articulated, segmented arms are available on the market from Lockwood Products under the registered trademark Loc-Line. The lengths of these arms will be such that the work area of the attached surgical practice device may be adjusted to be an appropriate distance (e.g., between 7 and 12 cm) below the upper edges of the box, according to the type of surgical procedure being simulated.

Each intermediate segment 28 of each arm has a ball on one end and a socket on the other end. Threaded adapter segments 30 are provided at the lower, secured ends of the arms 24 and 26, and also at the free end of arm 24. Each threaded adapter segment 30 is similar to an intermediate segment, but the exposed outer ball or socket, as the case might be, is replaced with a bore that is threaded on its inner diameter. A conical adapter 32 is provided at the free end of arm 26, on the other hand. Conical adapter 32 has a distal end that tapers conically toward a narrowed hollow point, to which other smaller elements may be attached.

A form holding annulus 34 is secured to the end of arm 24. The perimeter ring of the annulus 34 has a rectangular cross section and the inner diameter of the form holding annulus 34 is designed to function as a receptacle for receiving one or more cardiac surgical forms simulating the general size and shape of a chamber of the human heart. An attachment stub 36 projects radially from the perimeter ring and is threaded on its outer diameter so as to be received and firmly held by the threaded adapter 30 at the free end of arm 24.

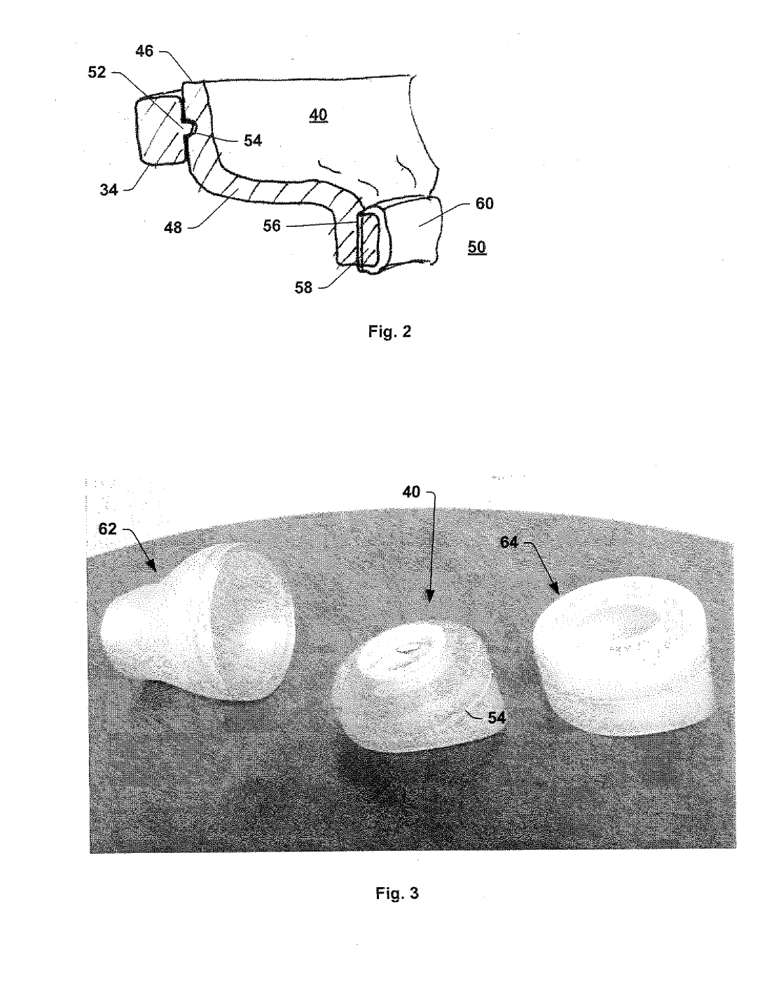

In FIG. 1, an aortic valve replacement simulator form 40 is contained in the form holding annulus 34. The form 40 mimics the size and shape of the interior of that portion of the heart that contains the aortic valve. The form 40 is rather bell-shaped, having a generally cylindrical perimeter wall 42 whose upper edge 46 is of smoothly varying height, and whose lower edge 48 folds radially inward toward a central cylindrical opening 50 (see FIG. 2). The opening 50 represents and mimics the location of the aortic valve.

As best seen in FIG. 2, the outer diameter of the form 40 matches the inner diameter of the form holding annulus 34 whereby the form is closely received by the form holding annulus. A ridge 52 extends around at least part of the interior diameter of form holding annulus 34. A narrow matching channel 54 extends at least partly around the outer diameter of form 40. Ridge 52 snaps into the channel 54 when the form 40 is pressed into holding annulus 34. The interlocking ridge and channel hold the form 40 in place but also, because of their cylindrical symmetry, permit the form 40 to be rotated within the annulus 34.

The central opening 50 is defined by the inner diameter 56 of the form 40. The opening 50 is dimensioned to receive a sewing ring 58 that has a covering 60 of suturable material, such as cloth or other material, that mimics the suturing properties (e.g., resilience, resistance to piercing or tearing) of tissue within the human heart. Sewing ring 58 and covering 60 have on inner diameter similar to the inner diameter of the root of a typical adult aorta. The inner diameter 56 of the opening 50 on the form 40 is slightly smaller than the outer diameter of the sewing ring 58 with its covering 60, whereby the sewing ring and its covering may be press fit into the opening 50 and will be held in place sufficiently by the friction of the fit.

In the embodiment presently being described, the suturable material 60 is cloth in the form of a sleeve that extends around the entire circumference of sewing ring 58. Sewing ring 58 may be split at one circumferential location to allow the fabric sleeve to be threaded over the sewing ring. The circumferential break will be held immobile by the opening 50, once the sewing ring has been inserted into the opening. Alternately, a suturable material may be directly formed on, or joined to, the outer diameter of the sewing ring 58.

It is anticipated that the sewing ring and its covering will be supplied on the market separately so that they may be replaced often. In addition, sewing rings may be made available with different sorts of coverings—some that have coverings more closely mimicking the sewing characteristic of valve annuli but requiring frequent replacement, and others that sacrifice some sewing realism for the sake of greater durability and thus longevity.

The apparatus may include multiple alternate heart cavity simulator forms, each of which may be snapped into holding annulus 34 in place of aortic valve replacement simulator form 40 to permit the surgeon to practice multiple different procedures. FIG. 3 shows the aortic valve replacement simulator form 40 accompanied by a mitrel valve replacement simulator form 62 and by an alternate aortic valve replacement simulator form 64. Each such form will have an outer diameter and circumferential groove similar to groove 54 of form 40, whereby the form may be snapped into holding annulus 34. The dimensions and profiles of the alternate forms will vary depending upon the needs of the intended training procedure.

Other attachments may be used in place of, or in addition to, the holding annulus 34. In FIG. 1 the second articulated arm 26 has a spring clamp 66 attached to the conical adapter 32 at the free end of the arm. Spring clamp 66 has two holding arms 68 and 70 pivotally joined by a common central pivot pin 72. A coil spring, not shown, is coaxial with pivot pin 72 and urges arms 68 and 70 toward a closed position. The clamp may be used by the surgeon to hold the simulated replacement heart valve (here, a simulated aortic valve 74 comprising another sewing ring having suturable material formed on its outer diameter).

The surgeon will hone his skills at aortic valve annulus suturing and mitral valve annulus suturing through use of the appropriate heart cavity simulator form and a simulated aortic or mitral replacement valve. Simulated replacement valves will be provided with the training apparatus. Each such simulated valve may take any desired form, so long as the size and shape of the simulated valve match the size and shape of the valve being simulated. Further, the simulated valve must be covered with a suturable material. The simulated valve may be similar to sewing ring 58 with its covering 60, although it will be of somewhat smaller diameter so that it may nest within the sewing ring. The surgeon will position the simulated replacement valve in the sewing ring within the heart cavity simulator form, and will suture the simulated replacement valve in place using long needle drivers and other typical surgical instruments.

When practicing mitral annulus and aortic annulus suturing, elements of the apparatus will be twisted about on the articulated arms to achieve maximum realism. For example, to mimic the angle of the mitral annulus, the surgeon will tilt the form so that the sewing ring 58 forms an angle of approximately 70 degrees with the base of the box. To mimic the angle of the aortic annulus, on the other hand, the sewing ring 58 will be tilted at an angle of about 30 degrees with the base of the box. In any case, the confined space provided by the form 40 will mimic the open heart chamber and will force the surgeon to sew within confines similar to the spaces found in the human heart.

Beyond mitral annulus suturing and aortic valve annulus suturing, a cardiothoracic surgeon encounters such further challenges as cannulation, coronary anastamosis, aortic graft anastamosis, and knot tying. The present apparatus allows the surgeon to practice each such procedure.

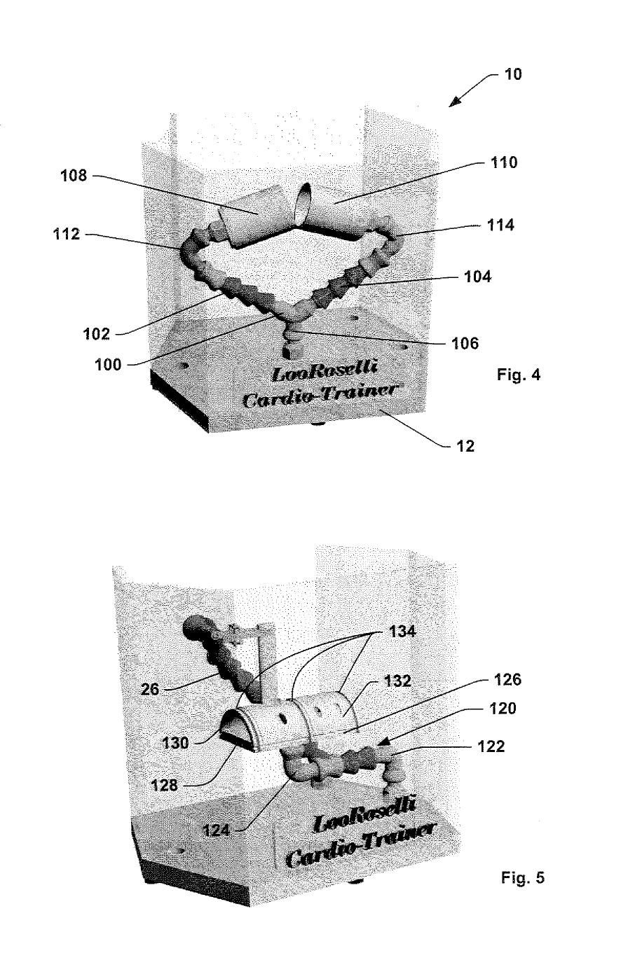

In FIG. 4, apparatus 10 is set up for aortic graft to graft anastamosis practice. As shown in the figure, the articulated arms 24 and 26 of FIG. 1 have now been replaced with a Y-shaped articulated arm structure to simulate anastamosis between a graft material and the aorta at a variety of angles deep within the mediastinum. The arm structure is formed of individual segments as described previously, but with an intermediate “Y” adapter 100 permitting two arms 102 and 104 to be joined pivotally to a common bottom segment 106. The bottom segment 106 of the Y-shaped articulated arm structure is attached to the base 12, and each of the arms 102, 104 is affixed to a respective cylinder 108, 110 representing the two ends of a severed aorta. The cylinders 108, 110 will each be covered by fabric sleeves or some other suturable material, at least near the open end of each cylinder, so that the surgeon may bring the cylinders into coaxial abutment and suture together the open ends thereof. The material should be durable enough so that it may be used multiple times before requiring replacement, but thin enough to mimic the challenge of performing an anastamosis with 7-O prolene sutures. It will be noted that arms 102, 104 include respective right-angle elbows 112, 114 to permit the two open cylinder ends more easily to be brought into alignment.

The coronary anastamosis drills will involve a synthetic thin tube that acts as the conduit and a tube of similar or larger diameter to act as the coronary target. A similar but larger tube is used for aortic suture drills. Tying knots will be practiced on a soft material that deforms enough to allow the knots to be placed under tension forcing the surgeon to exert only the appropriate amount of force without breaking the suture. Finally the annular suturing drills will involve suturing through an annuloplasty-like material in a ring formation with continuous or interrupted sutures.

In FIG. 5, apparatus 10 is set up for coronary lateral anastamosis practice. The apparatus still includes articulated arm 26 for supporting a spring clamp, but articulated arm 24 has now been replaced by a different arm structure, generally indicated at 120. Arm structure 120 includes two right-angle elbows 122, 124, and carries a frame 126 having the form of a section of a cylinder. Frame 126 mimics the curved surface of an aorta, pulmonary artery, etc. requiring lateral anastamosis. Frame 126 has a rectangular support base 128 and a series of three or more arch supports 130 at spaced locations along the length of the support base. A flexible fabric or similar sheet material 132 is draped over the arches and held in place by resilient bands 134 aligned with the arch supports 130. As shown in the Figure, the sheet has 8 mm holes punched in different locations and orientations to simulate a variety of distal coronary targets.

Moreover, although the fabric 132 is shown in FIG. 5 with extant holes, other coverings will be provided that lack such holes and which will therefore be suitable for practice by a surgeon in cutting typical openings for cannulation or anastomosis. The uninterrupted fabric covering may be formed of the same material as the fabric shown in the Figure, but may instead be formed of a different material that optimizes the fidelity of the simulation by closely mimicking the resistance to initial penetration and incisions by a typical scalpel or other surgical instrument.

For cannulation practice, the surgeon performing the exercise would pierce the sheet to create openings into which cannulas would be inserted. The curved surface presented by the fabric 132 will force the surgeon to negotiate challenging needle angles while performing purse strings for a variety of aortic, venous and cardioplege cannulas.

A number of different configurations can be used for any of the above drills to increase complexity.

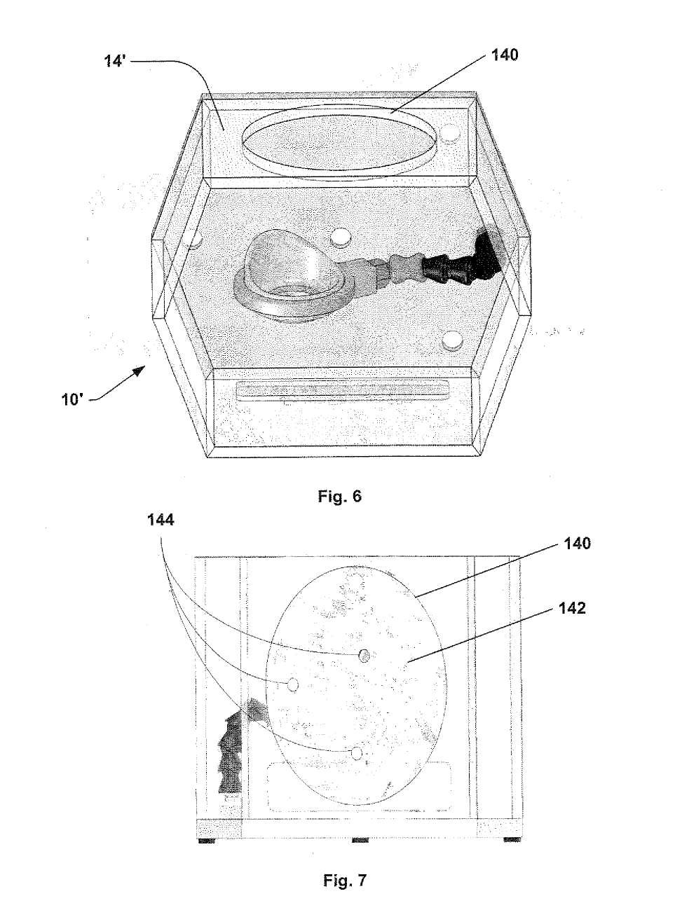

In FIG. 6 there is illustrated an embodiment of the trainer apparatus 10 in which one of the side panels 14′ is provided with an auxiliary opening 140. The auxiliary side opening 140 provides an access opening through which procedures may be practiced, where the access opening is more confined than the top opening of the apparatus. In the FIG. 6 embodiment, the auxiliary side opening 140 is generally ovular, having a transverse diameter that is moderately smaller than the transverse dimension of the side panel 14′ upon which the opening is formed. In practice, the surgeon will position the trainer 10′ on a stable platform or table, resting the apparatus 10′ on the side panel that is diametrically opposite to the panel 14′ having the auxiliary side opening, where by the auxiliary side opening will be presented at the top, or uppermost surface of the apparatus 10′. The opposite side panel, now on the bottom, may be provided with a number of rubber feet to facilitate and stabilize this positioning. The rubber feet are not shown in FIG. 6 but may be similar to the base feet that are partially visible in other Figures.

The opening 140 accommodates the surgeon's hands and instruments during practice procedures, but the space thereby provided is smaller and more restricted than the top opening of the trainer. The smaller opening 140 mimics the more restricted space available in some surgical procedures, including for example pediatric procedures and certain thoracotomy procedures. The procedures will actually be performed upon interior inserts and fixtures that are the same as, or similar to, the inserts and supporting fixtures already described above with respect to other Figures.

To further enhance the utility of the trainer for a wide variety of procedures, other side panels may similarly be provided with other openings of different sizes and/or shapes. If the apparatus 10 is thus provided with multiple auxiliary side openings, the surgeon may chose a desired practice environment merely by positioning the trainer so that the preferred opening is presented on the uppermost surface of the trainer. Alternatively or in addition, the apparatus 10 may be supplied with a number of interchangeable covers having different sized openings similar in purpose and form to the opening 140 illustrated in FIG. 6. Each such cover will be provided with tabs that snap into matching detents near the top of the trainer, thereby to secure the cover to the top of the trainer with enough strength that the cover will not be dislodged during practice by the surgeon. Of course, other positive fastening features and techniques may instead be employed. Moreover, the auxiliary opening may be formed on the bottom of the apparatus 10′, so long as the attachment points for the interior training components is moved from area at which the opening is formed (e.g., to the perimeter of the bottom or to a side wall).

In the FIG. 7 embodiment, the opening 140 is covered by a resilient insert 142 having multiple holes 144 penetrating the insert into the interior space within the apparatus 10′. The holes 144 provide ports through which the surgeon may insert various surgical instruments for practicing minimally invasive surgical (“MIS”) procedures. If the apparatus 10′ has auxiliary side openings on two or more adjacent side panels 14′, similarly ported covers may be provided for each auxiliary side opening to thereby present the surgeon with multiple different approach vectors for the interior locus of the practice procedure.

Preferably, the insert 142 will be formed of a material having a resilience and thickness that mimics the tissue through which a minimally invasive surgical procedure will be performed. In the embodiment illustrated, the insert is fastened in the auxiliary side opening by a snap fit arrangement. The snap fit positively locks the insert into the side auxiliary opening so as to prevent it from being dislodged during actual use. The snap fit arises from an annular ridge on the perimeter of the insert that snaps into a matching annular channel in the perimeter of the auxiliary side opening 140. Again, alternative fastening features or techniques may be used.

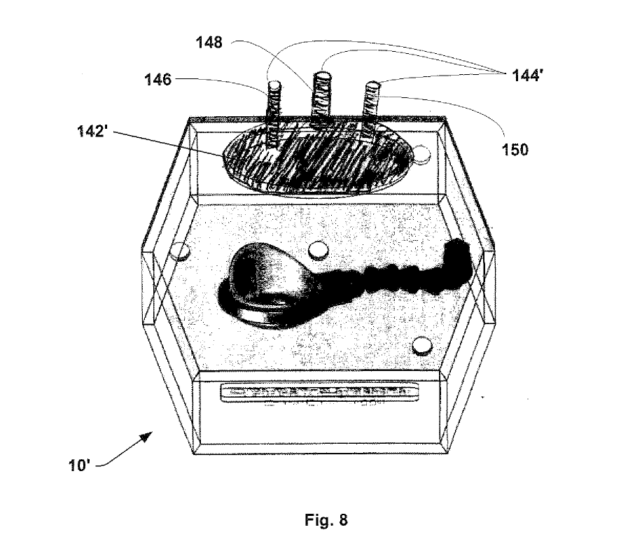

As an alternative to thickening the material of which the entire insert is formed, the material defining the inner diameters of the ports may protrude in a hose-like fashion from either side of the insert thereby to give the ports some axial length and in this manner mimic tissue depth without requiring a thickening of the entire expanse of the insert. This alternative is shown in FIG. 8, wherein tubes or hoses 146, 148, and 150 project through the insert 142′ and the ports 144′ are represented by the hollow axial cores of the tubes. The tubes may be molded into the insert, but will preferably be inserted through and held frictionally by grommets in the insert (not separately shown) so that hoses of different dimensions may be used to provide different practice environments.

From the above description of the invention, those skilled in the art will perceive improvements, changes and modifications. Such improvements, changes and modifications within the skill of the art are intended to be covered by the appended claims.

Having described the invention, the following is claimed:

1. Surgical training apparatus comprising:
a box having a base and side walls, said side walls surrounding said base, said base having a top with an opening therein, said box being sized so that said top opening is large enough to at least partially receive the hands of a surgeon and thereby to simulate a body opening through which a surgical procedure is manually performed;
at least one elongated, articulated support arm disposed within said box; and
at least one surgical practice form affixed to at least one end of said support arm.

2. Surgical training apparatus as set forth in claim 1, wherein said support arm has at least two ends, one of said ends of said support arm is fixed to at least one of said base and said side walls, said base has at least two fastening features at different locations thereon, and said support arm may be removably attached to different ones of said at least two fastening features.

3. Surgical training apparatus as set forth in claim 1, wherein said support arm comprises a series of interlocking ball and socket segments that may be manipulated to assume various positions, and wherein said ball and socket segments provide sufficient resistance to movement that said support arm will tend to remain in a position in which it has been moved.

4. Surgical training apparatus as set forth in claim 1, further comprising an adapter mounted at said at least one end of said support arm, said adapter having a receptacle formed therein, and multiple surgical practice forms, each adapted to be interchangeably received in and held by said receptacle.

5. Surgical training apparatus as set forth in claim 4, wherein said adapter comprises an annular ring, the inner diameter of said ring representing said receptacle, and wherein each of said multiple surgical practice forms is adapted to be received in said inner diameter.

6. Surgical training apparatus as set forth in claim 4, wherein at least one of said multiple surgical practice forms has a shape designed to mimic the size and shape of the interior of that portion of the heart that contains the heart valve.

7. Surgical training apparatus as set forth in claim 1, wherein said at least one surgical practice form is at least partially formed of suturable material.

8. Surgical training apparatus as set forth in claim 7, wherein said surgical practice form is sized and configured to mimic one of (a) a chamber of the human heart holding an aortal valve, (b) a chamber of a human heart holding a mitral valve, (c) an aorta or pulmonary artery.

9. Surgical training apparatus as set forth in claim 1, and further comprising a cover removably attachable to at least one surface of said box, said cover having ports therein through which instruments may be inserted for the practice of minimally invasive surgical procedures.

10. Surgical training apparatus as set forth in claim 1, wherein said elongated articulated support arm comprises at least two elongated articulates support arms, wherein said at least one surgical practice form is affixed to an end of one of said at least two arms, and further comprising an element affixed to an end of a second of said at least two arms, wherein said element is at least one of (a) a clamp, and (b) a second surgical practice form.

11. Surgical training apparatus as set forth in claim 10, wherein said at least two arms are connected to one another in a “Y” configuration.

12. Surgical training apparatus as set forth in claim 10, wherein said first and second surgical practice forms have tube or conduit like forms, dimensioned and configured to be suitable for practicing at least one of cannulation and anastamosis procedures.

13. Surgical training apparatus as set forth in claim 12, wherein each of said first and second surgical practice forms is at least partially formed of suturable material.

14. Surgical training apparatus comprising:
a box having a base and side walls surrounding said base, said base having a top with an opening therein, said box being sized so that said top opening simulates a body opening through which the hands of a surgeon may at least partially be inserted to perform a surgical procedure;
at least one surface of said box, other than said top, having an auxiliary opening sized differently than said top opening, thereby to simulate a differently sized body opening; and,
at least one surgical practice form disposed within said box and accessible for surgical practice through at least one of said top opening and said auxiliary opening.

15. Surgical training apparatus as set forth in claim 14, wherein said at least one surface of said box, other than said top, comprises at least one side wall of said box.

16. Surgical training apparatus as set forth in claim 14, and further comprising a cover for at least one of said top opening and said auxiliary opening, said cover having ports therein through which instruments may be inserted for the practice of minimally invasive surgical procedures.

17. Surgical training apparatus as set forth in claim 16, wherein at least the portion of said cover in the vicinity of said ports has a resilience and depth mimicking the resilience and depth of body tissue through which a minimally invasive surgical procedure would be performed.

18. Surgical training apparatus as set forth in claim 14, and further comprising an elongated articulated support arm for flexibly attaching said surgical practice form to said box.

19. Surgical training apparatus as set forth in claim 14, wherein at least one of said surgical practice forms is at least partially formed of suturable material.

20. Surgical training apparatus comprising:
a portable box having an opening therein, said box having a size and volume small enough that said box may be conveniently carried from place to place and stored when not in use;
a covering for said opening, said covering having plural small ports therein through which surgical instruments may be inserted to access the interior of said box; and,
at least one surgical practice form affixed within said box and accessible through at least of said plural ports for manual practice of minimally invasive surgical procedures.

21. Surgical training apparatus as set forth in claim 20, wherein said cover is removable from said box thereby to expose said opening for access to the interior of said box.

22. Surgical training apparatus as set forth in claim 20, and further comprising an elongated articulated support arm for flexibly connecting said surgical practice form within said box.

23. Surgical training apparatus as set forth in claim 20, wherein at least one of said surgical practice forms is at least partially formed of suturable material.

24. Surgical training apparatus as set forth in claim 20, wherein at least the portion of said cover in the vicinity of said ports has a resilience and depth mimicking the resilience and depth of body tissue through which a minimally invasive surgical procedure would be performed.

25. Surgical training apparatus as set forth in claim 20, wherein at least a portion of said box is formed of transparent material.
